(19) United States
(12) Patent Application Publication
(10) Pub. No.: US 2014/0098534 A1
(43) Pub. Date: Apr. 10, 2014

(54) SYSTEM AND METHOD FOR LASER DIODE ARRAY

(71) Applicant: Lawrence Livermore National Security, LLC, Livermore, CA (US)

(72) Inventor: John Larkin JACKSON, Livermore, CA (US)

(73) Assignee: LAWRENCE LIVERMORE NATIONAL SECURITY, LLC, Livermore, CA (US)

(21) Appl. No.: 13/972,278

(22) Filed: Aug. 21, 2013

Related U.S. Application Data
(60) Provisional application No. 61/711,668, filed on Oct. 9, 2012.

(51) Int. Cl. F21V 5/04; F21V 5/02

(52) U.S. Cl. CPC F21V 5/04; F21V 5/045; F21V 5/02
USPC 362/237; 29/592.1

(57) ABSTRACT

The present disclosure relates to a laser diode array which may be made up of at least two unit cells. Each unit cell may have a stack of laser diodes and a focusing lens. The focusing lens of each unit cell may be used to focus an output beam from its associated unit cell. The unit cells may be arranged so that the focused output beams from the unit cells converge on a common focal region.

### CROSS-REFERENCE TO RELATED APPLICATIONS

This application claims the benefit of U.S. Provisional Application No. 61/711,668 filed on Oct. 9, 2012. The disclosure of the above application is incorporated herein by reference.

### STATEMENT OF GOVERNMENT RIGHTS

The United States Government has rights in this invention pursuant to Contract No. DE-AC52-07NA27344 between the U.S. Department of Energy and Lawrence Livermore National Security, LLC, for the operation of Lawrence Livermore National Laboratory.

### FIELD

The present disclosure relates to laser diodes, and more particularly to a conformal lens array for focusing beams generated by the lens packets of a laser diode system into a line, ellipse, or a pattern having a desired shape.

### BACKGROUND

The statements in this section merely provide background information related to the present disclosure and may not constitute prior art.

A present day, high power laser diode assembly is shown in FIG. 1. Such a laser diode assembly typically is made up of numerous rows or bars comprising multiple laser diodes, a micro optics package and occasionally a focusing lens or grating which may be built into the diode window or micro optics. The entire assembly is referred to as a “unit cell”. A plurality of unit cells may be used to construct a laser diode array combining the power of the many layer diodes.

Each unit cell produces an output beam which is highly divergent along one axis (i.e., its “fast divergence axis”) and much less divergent in its other orthogonal axis (i.e., its “slow divergence axis”). For unit cells used by the assignee of the present application, the fast divergence axis corresponds to the major dimensional axis of a rectangular unit cell and the slow divergence axis corresponds to the minor dimensional axis of the unit cell. Of course, the opposite may be the case depending on how the unit cells are configured by the manufacturer. Typically one axis may produce divergence which is greater by a factor of 10 or more than the divergence of the other axis. This makes it especially difficult to superimpose the outputs of multiple unit cells into a common focus or beam waist so that the entire optical energy from an array of unit cells can be focused on a predefined, narrow target region.

Previous efforts to superimpose the outputs from the lenses of a plurality of unit cells of a laser diode array have used large lenses. More particularly, a single large lens has been used to receive the outputs from a plurality of unit cells. However, the use of a single large lens to try and focus the outputs from an array of unit cells has significant drawbacks. One is that a single large lens that is receiving the outputs from an array of laser diode unit cells can be relatively quick to overheat. Another is that the use of a single large lens is practical only when superimposing the outputs from a relatively small array of unit cells.

Other techniques to focus the collective output beams of a laser diode array have involved the use of light pipes or light ducts to concentrate the energy to a small aperture. The disadvantage of a light duct is that the beam divergence at the aperture is increased in direct proportion to the amount of concentration of the duct according to the optical invariant. This effect lowers efficiency and can cause excess heating of objects positioned close to the aperture. Light ducts must also be used with little spacing between duct and target to preserve efficiency. So the use of light ducts limits the standoff distance from the unit cell to the target, and thus typically requires the unit cell to be positioned relatively close to the target. This limitation can make use of a laser diode array impractical or impossible in applications where it is difficult, impossible or undesirable to physically mount the laser diode array close to the target.

### SUMMARY

In one aspect the present disclosure relates to a laser diode array. The array may have at least two unit cells. Each unit cell may comprise a stack of laser diodes and a focusing lens for focusing an output beam therefrom. The unit cells are arranged so that the focused output beams from the unit cells converge on a common focal region.

In another aspect the present disclosure relates to a laser diode array comprising a plurality of unit cells. Each unit cell may have a laser diode stack and a focusing lens, and generates an output beam. A frame structure may be included for supporting at least one of the unit cells or the lens of the unit cells in a predetermined configuration. This enables the focusing lenses of the unit cells to collectively focus the output beams to a target region. The target region may include at least one of a line or a small ellipse region having a predetermined cross sectional configuration.

In still another aspect the present disclosure relates to a method for forming a laser diode array. The method may comprise providing an array of at least two unit cells, with each unit cell comprising a stack of laser diodes and a focusing lens for focusing an output beam therefrom. The unit cells are arranged so that the focused output beams converge and substantially overlap at a target region.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level perspective view of a prior art laser diode array and its associated focusing lens, which together are known in the art as a “unit cell”;

FIG. 2 is a high level side view of one embodiment of an array in accordance with the present disclosure in which a plurality of unit cells are arranged along a flat plane but angled to focus their output beams on a target region;

FIG. 3 is a high level side view of a “wedged lens” being used to bend the output beam from a unit cell to a point that is off-axis from where the output beam would otherwise be focused without the wedged lens. It can be seen that a wedged lens is equivalent to a tilted lens and prism in combination;

FIG. 3a illustrates how the wedged lens of FIG. 3 effectively makes up a portion of a single larger lens;

FIG. 4 illustrates how a plurality of wedged lenses may be used to bend the output beams from a plurality of unit cells so that the output beams converge and are substantially or fully superimposed on each other at a target region;

FIGS. 5 and 6 are graphs illustrating how the lens of FIG. 1 is able to modify (i.e., reduce) the degree of divergence of the slow divergence axis of a 2×20 diode bar unit cell;

FIGS. 7 and 8 are graphs illustrating how the lens of FIG. 1 is able to significantly modify the degree of divergence of the fast divergence axis of a 2×20 diode bar tile unit cell;

FIG. 9 is a high level perspective view showing a plurality of unit cells being used to form a conformal array in accordance with another embodiment of the present disclosure; and

FIG. 10 shows how the conformal array of FIG. 9 may focus the output beams from the individual unit cells onto a relatively small target region.

### DETAILED DESCRIPTION

The following description is merely exemplary in nature and is not intended to limit the present disclosure, application, or uses. It should be understood that throughout the drawings, corresponding reference numerals indicate like or corresponding parts and features.

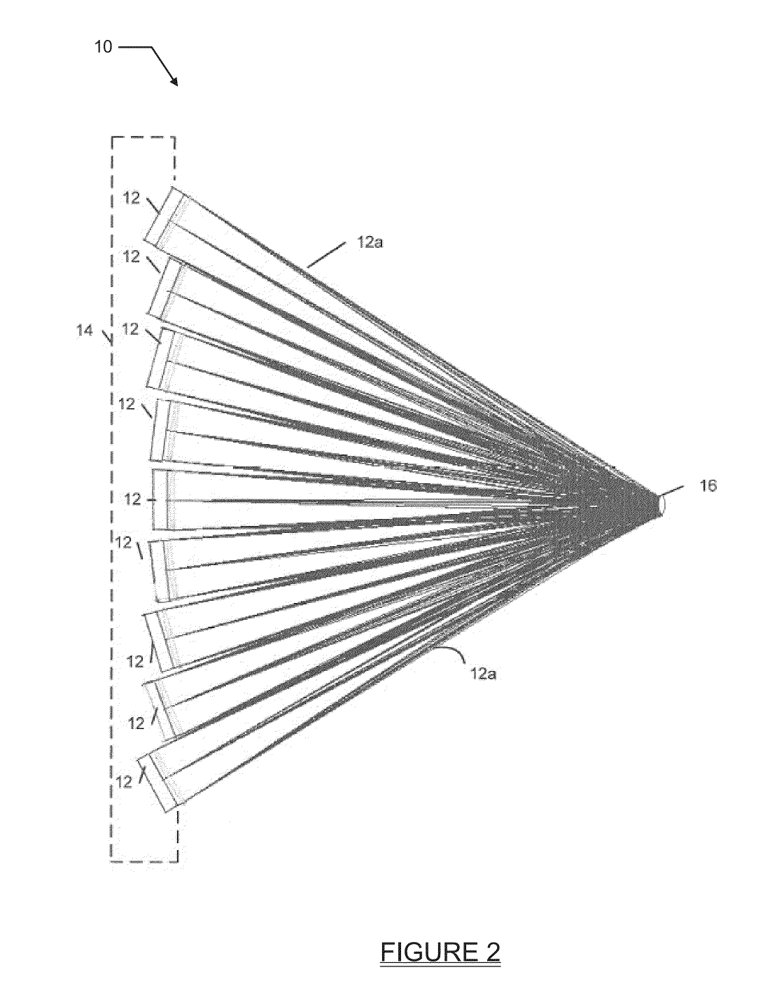

Referring to FIG. 2, a high power diode array 10 is shown in accordance with one embodiment of the present disclosure. The array 10 makes use of a plurality of unit cells 12 that are supported generally along a flat plane by a suitable support structure 14. Each unit cell 12 is tilted as needed to aim its output beam 12a at a target region 16. The tilting may be at any angle greater than or equal to zero degrees and less than 90 degrees, relative to a flat plane that the unit cell is referenced to. The output beams 12a from the unit cells 12 thus substantially or virtually completely overlap (i.e., are superimposed on one another) at the target region 16 enabling a much greater degree of optical energy to be focused at the target region.

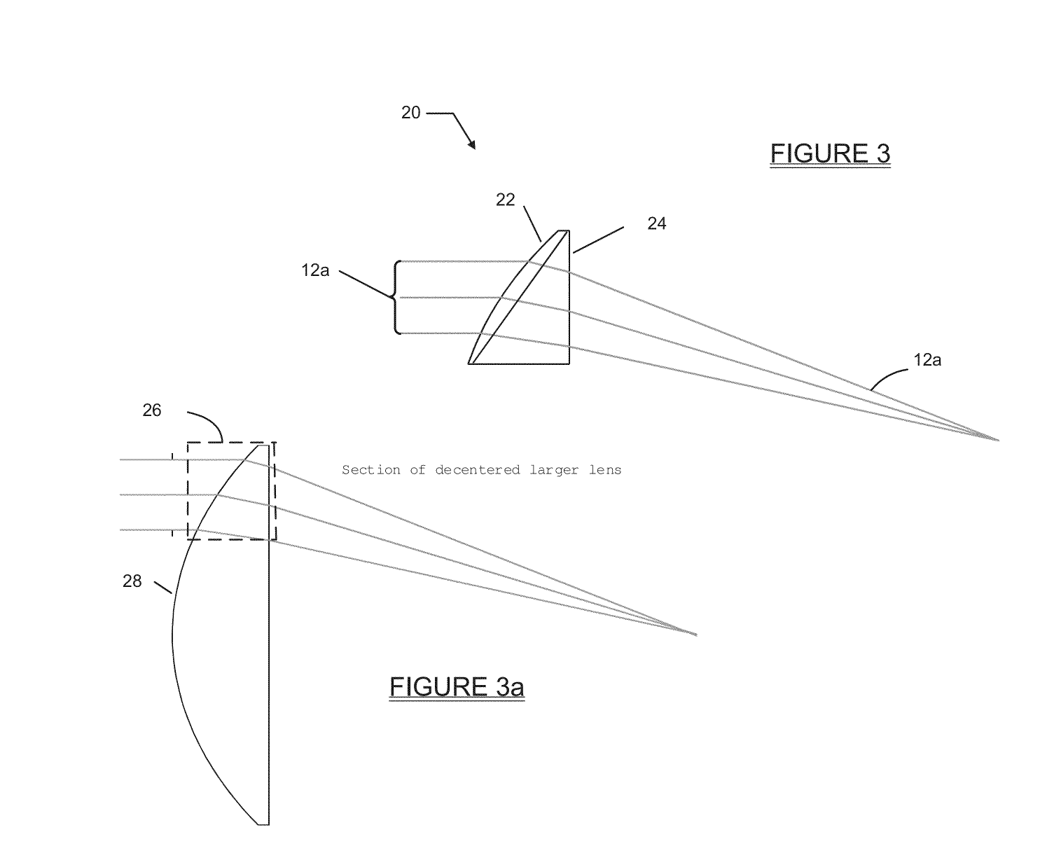

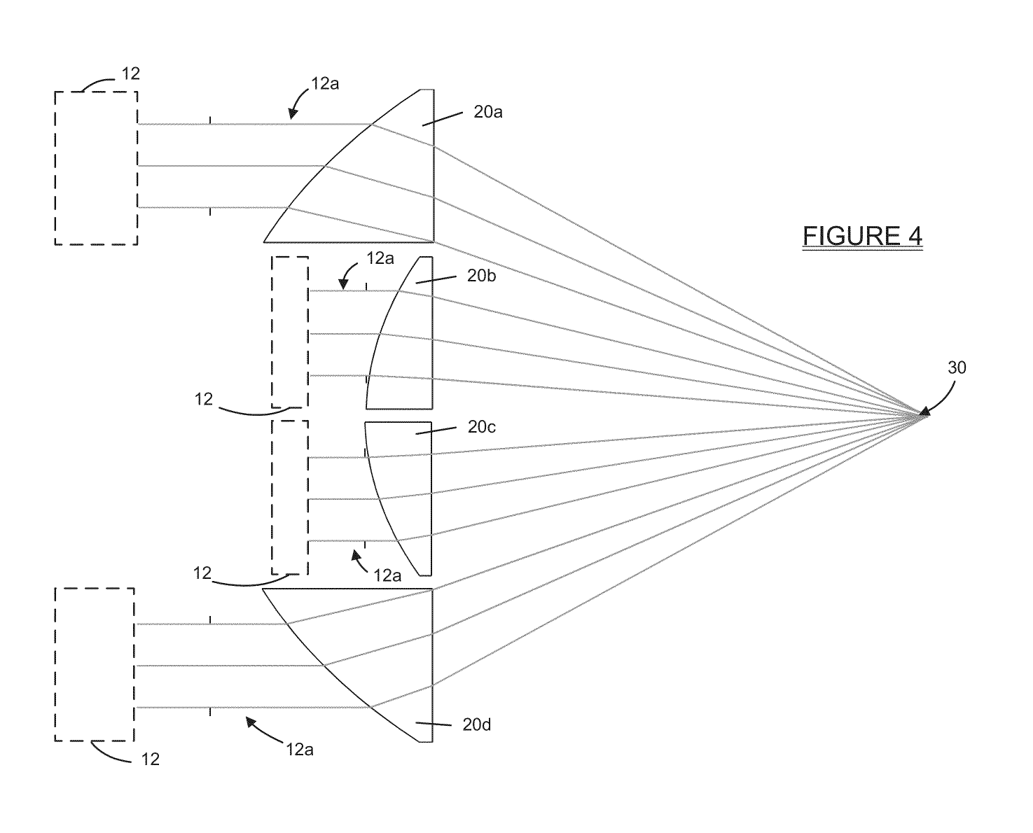

Referring to FIG. 3, a wedged lens assembly 20 is shown in accordance with another embodiment of the present disclosure. The wedged lens assembly 20 may include a lens element 22 and a prism 24. The combination of lens 22 and prism 24 enables the output beam 12a from a unit cell or diode array (not shown) to be diverted “off axis”, or in other words “bent” in one or both of the X and Y axes of a given plane parallel to a face of the unit cell 12, and directed at a specific target region. In effect, the wedged lens assembly 20 essentially forms a portion 26 of a larger decentered lens 28, as shown in FIG. 3a. FIG. 4 illustrates how a plurality of wedged lenses 20a-20d may be used to bend the output beams 12a from a plurality of diode arrays or unit cells 12 so that the output beams converge and are superimposed on one another at a small target region 30. It will be appreciated that the target region 30, which is shown as a point in FIG. 4, may be a line, a circle, an ellipsoid, an oval shape or virtually any other predetermined two-dimensional shape, depending on the precise configuration of the wedged lenses 20a-20d. An advantage of the using the wedged lenses 20a is that the unit cells 12 (FIG. 2) may all be arranged parallel to, or in, a single flat plane.

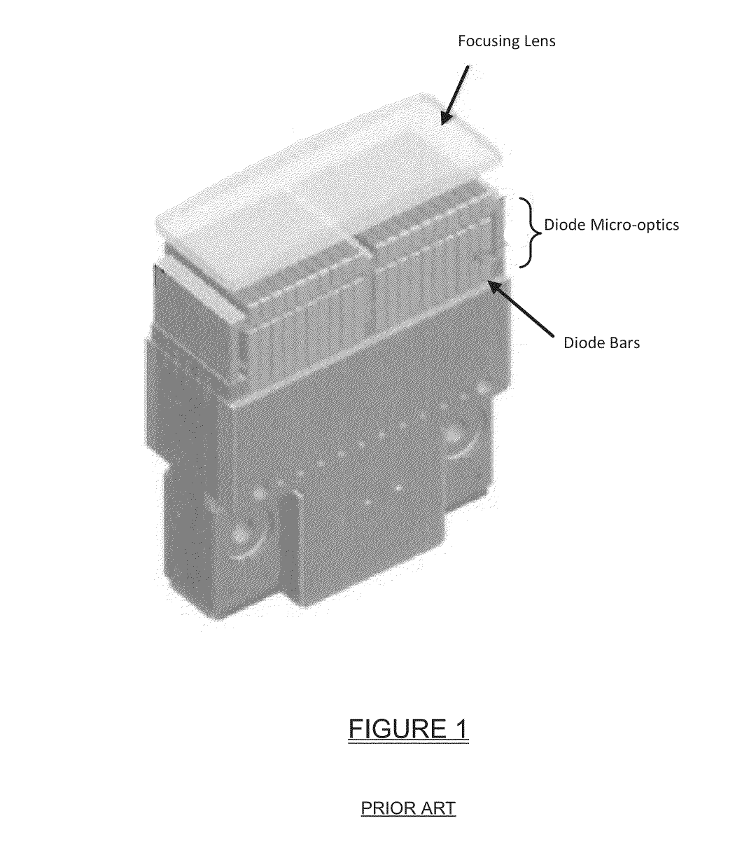

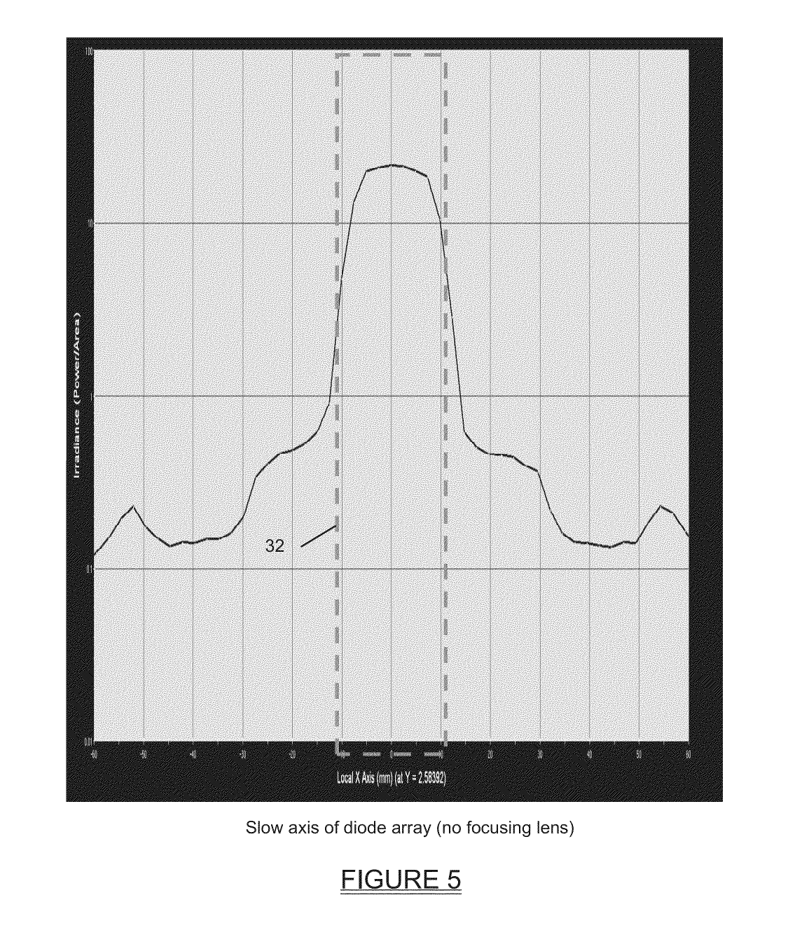

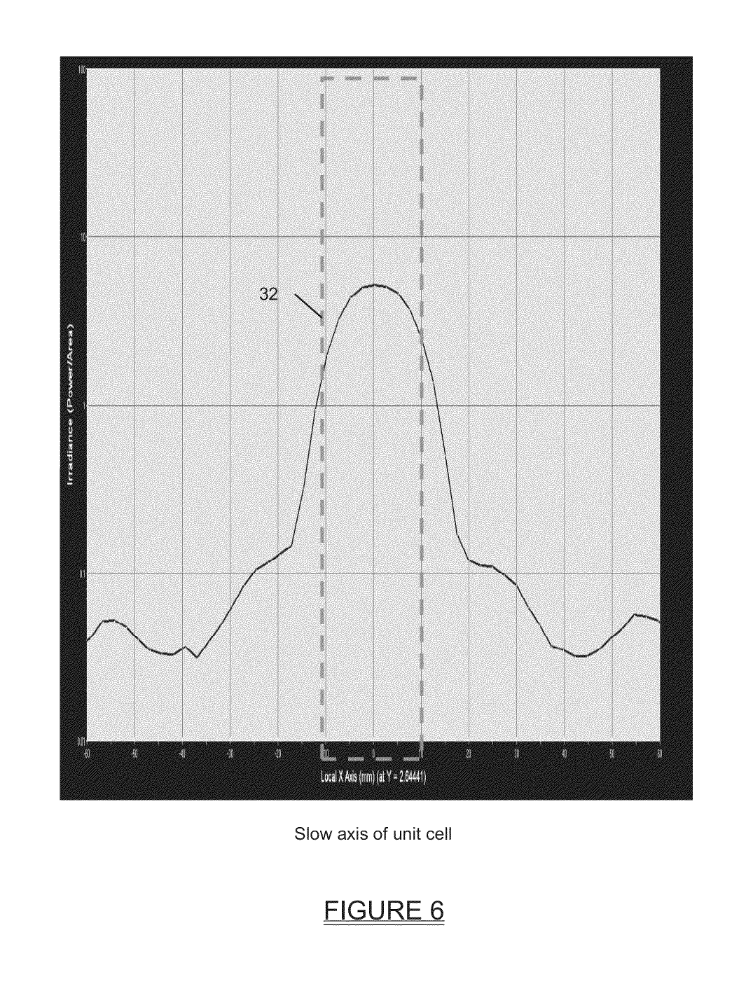

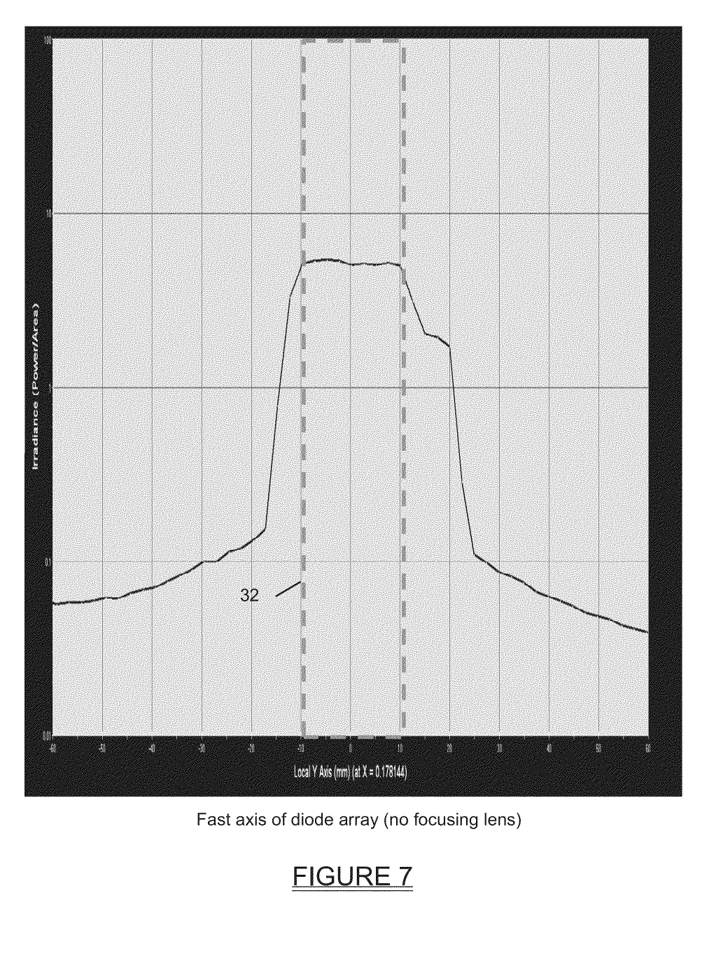

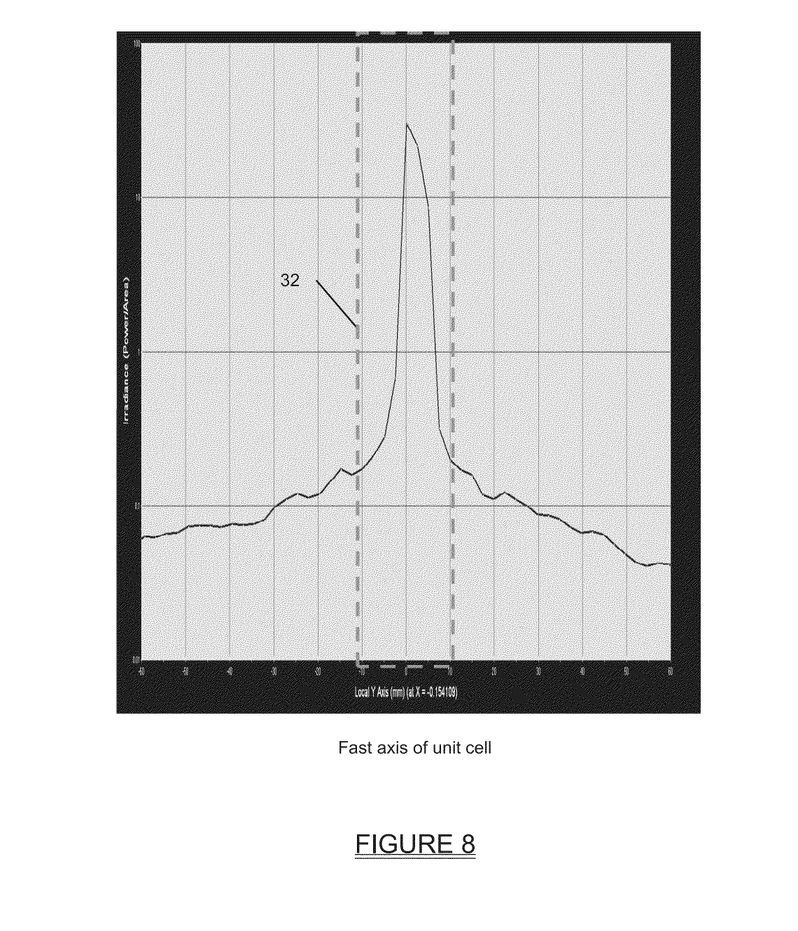

FIGS. 5 and 6 illustrate the change in slow axis divergence for a 2×20 diode bar unit cell achieved with the lens 20 of FIG. 1. FIGS. 7 and 8 illustrate the change in divergence along the fast divergence axis of the same 2×20 diode bar unit cell.

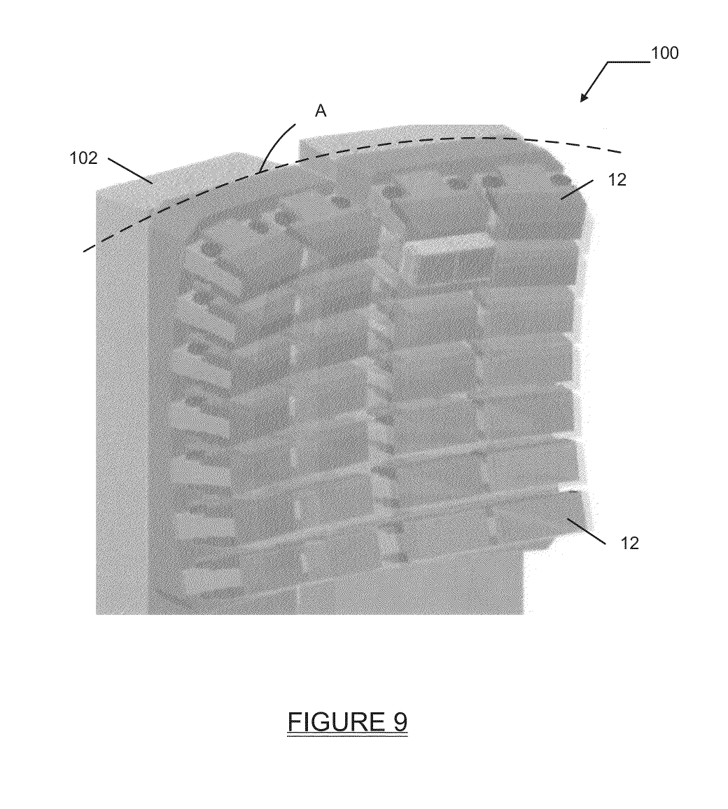

Referring to FIG. 9 an conformal array 100 is shown in accordance with another embodiment of the present disclosure. The array 100 is termed a “conformal” array because the unit cells 12 are arranged about a non-planar surface, for example a portion of a spherical, ellipsoidal, cylindrical, parabolic or other non-planar, geometric shape which allows the focal waist of each unit cell 12 to be aimed in a single concentrated area. The concentrated area (i.e., target region) is formed by the overlap of multiple foci and may be a line, ellipse, circular spot, rectangular spot, or virtually any other configuration. FIG. 9 also illustrates a frame structure 102 with a partial spherical shape, but as noted above, the conformal array 100 is not limited to a spherical configuration. Each unit cell 12 is tilted such that its lens is positioned in a plane that is parallel to the tangent at the point on the arc “A” on which the unit cell 12 is located. The unit cells 12 may be supported on the frame structure 102, or they may be at least partially embedded in the frame structure. Alternately, the frame structure 102 may form a grid of rails or like members from which the unit cells are supported, and where the grid forms the desired conformal contour for the array 100. It is expected that in most applications the unit cells 12 will be bolted on to the frame structure 102. The frame structure 102 may contain the electrical lines, the water cooling lines and air cooling lines (all not shown) which mate with appropriate connecting structure on each unit cell 12 to provide power and thermal management.

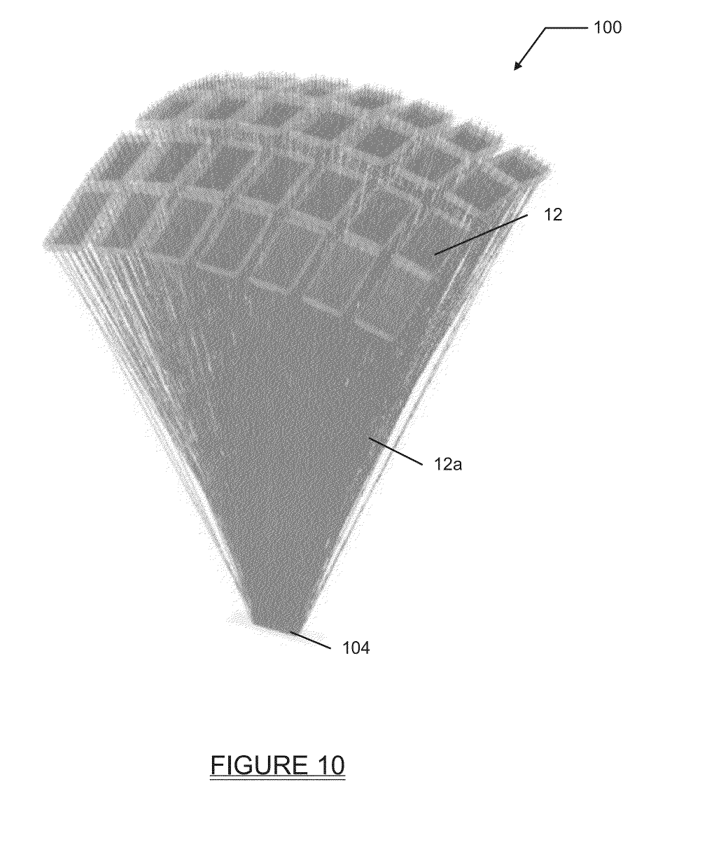

FIG. 10 illustrates how the foci of the output beams 12a from the unit cells 12 of the array 100 substantially overlap one another and converge upon a relatively small, rectangular concentrated area which forms the target region 104. One will appreciate that with the spherical configuration of array 100, changing the radius of the sphere will affect the distance to the center of the sphere, and thus the size and/or configuration of the target region. The same would be true for any sphere-like geometry, as well as a circular geometry.

The various embodiments described herein are expected to significantly broaden the applications in which laser diodes can be used, but at the present time are not being widely used because of the present day limitations on the levels of irradiance that can be generated using laser diodes and conventional larger lenses and light ducts. Such expanded applications are expected to include, but are not limited to, the following: metal cutting; drilling; rapid heating/melting; soldering/brazing/welding; polymer welding; bending; printing technology; metal hardening; high intensity illumination; material processing; scribing; medical procedures; cladding and paint stripping.

A conformal array, and the use of individual small lenses on the unit cells 12, provides a number of advantages including, but not limited to: modularity, which can reduce overall costs; significantly lower internal heating of components; less risk of damage to optical components; higher optical and electrical efficiency; better scalability; an easily scalable beam waist; and a faster processing than what is possible with conventional methods. The array of the present disclosure also enables a greater quantity of diode light to be focused than prior art arrays.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A laser diode array, comprising:
an array of at least two unit cells, each said unit cell comprising a stack of laser diodes and a focusing lens for focusing an output beam therefrom, wherein the unit cells are arranged so that the focused output beam from each unit cell converge on a common focal region.

2. The laser diode array of claim 1, wherein the unit cells are arranged along a non-flat plane so that the focused output beam of each said unit said cell is orthogonal to a corresponding tangent of the curved plane, at each said unit cell.

3. The laser diode array of claim 1, wherein the non-flat plane comprises a spherical plane.

4. The laser diode array of claim 1, wherein the non-flat plane comprises a portion of a cylindrical plane.

5. The laser diode array of claim 1, wherein the non-flat plane comprises a portion of an elliptical plane.

6. The laser diode array of claim 1, wherein the non-flat plane comprises a portion of a parabolic plane.

7. The laser diode array of claim 1, wherein the unit cells are arranged along a flat plane and each said unit cell is individually tilted relative to the flat plane at an angle greater than or equal to zero degrees and less than 90 degrees.

8. The laser diode array of claim 1, wherein the unit cells are arranged along a flat plane, with the focusing lens of each said unit cell adapted to focus the output beam toward the common focal region.

9. The laser diode array of claim 8, wherein the focusing lens comprises at least one of:
a wedged lens; and
a lens having a prism for altering a direction of the output beam toward the common focal region.

10. The laser diode array of claim 8, wherein the common focal region comprises at least one of:
a line of predetermined length; and
an area having a predetermined two dimensional configuration.

11. A laser diode array comprising:
a plurality of unit cells, each said unit cell having a laser diode stack and a focusing lens and generating an output beam;
a frame structure for supporting at least one of the unit cells or the lens of the unit cells in a predetermined configuration so that the focusing lenses of the unit cells collectively focus the output beams to a target region, and where the target region includes at least one of:
a line; or
a region having a predetermined cross sectional configuration.

12. The laser diode array of claim 11, wherein the frame structure supports each of the unit cells in a curved plane so that the output beam of each said unit cell is orthogonal to the curved plane.

13. The laser diode array of claim 11, wherein the curved plane comprises at least one of:
a curved structure on which the unit cells may be supported; or
a grid-like structure or members from which the unit cells may be at least one of supported on or suspended from.

14. The laser diode array of claim 11, wherein the predetermined configuration comprises a flat plane, and where each of the unit cells are individually tilted with respect to the flat plane, so that the output beams of the unit cells are steered toward the target region.

15. The laser diode array of claim 11, wherein the predetermined configuration comprises a flat plane, and wherein the laser diode stacks of the unit cells are all arranged in the flat plane, and wherein the focusing lens of each said unit cell is tilted off-axis from a plane of its associated said diode stack to independently steer the output beam from its associated said diode stack toward the target region.

16. A method for forming a laser diode array, comprising:
providing an array of at least two unit cells, each said unit cell comprising a stack of laser diodes and a focusing lens for focusing an output beam therefrom; and
arranging the unit cells so that the focused output beams converge and substantially overlap one another at a target region.

17. The method of claim 16, wherein the arranging of the unit cells comprises arranging the unit cells along a flat plane.

18. The method of claim 16, wherein the arranging of the unit cells comprises arranging the unit cells along a curved plane.

19. The method of claim 18, wherein the arranging of the unit cells along a curved plane comprises arranging the unit cells in at least one of:
a partially spherical configuration;
a partially circular configuration;
a partially ellipsoidal configuration; and
a partially parabolic configuration.

20. The method of claim 16, wherein the arranging of the unit cells comprises arranging the unit cells such that the stacks of diodes of the unit cells are arranged generally parallel to one another; and
using wedged lenses for at least some of the unit cells to alter the output beams from the diode stacks such that the output beams from all of the unit cells converge at the target region.
